(19) United States
(12) Patent Application Publication
(10) Pub. No.: US 2019/0243485 A1
(43) Pub. Date: Aug. 8, 2019

(54) TOUCH INPUT DEVICE

(71) Applicant: HiDeep Inc., Seongnam-si (KR)

(72) Inventor: Hyukjae CHOI, Seongnam-si (KR)

(21) Appl. No.: 16/266,045

(22) Filed: Feb. 2, 2019

(30) Foreign Application Priority Data
Feb. 6, 2018 (KR) 1020180014768

(51) Int. Cl. G06F 3/044; G06F 3/041

(52) U.S. Cl. CPC G06F 3/044; G06F 2203/04102; G06F 3/0416

(57) ABSTRACT

A touch input device may be provided that includes a cover layer; a display module disposed under the cover layer; a substrate disposed apart from the display module at a predetermined distance; and a flexible printed circuit board (FPCB) on which a control circuit for controlling the operation of the display module is mounted. A pressure sensor for sensing touch pressure of an object is formed in a partial area of the FPCB.

### CROSS-REFERENCE TO RELATED PATENT APPLICATIONS

The present application claims priority to Korean Patent Application No. 10-2018-0014768, filed Feb. 6, 2018. The disclosure of the aforementioned priority application is incorporated herein by reference in its entirety.

### BACKGROUND

### Field

The present disclosure relates to a touch input device and more particularly to a touch input device which is made thinner by using an FPCB as a pressure sensor and has a lower manufacturing cost thereof.

### Description of the Related Art

Various kinds of input devices are being used to operate a computing system. For example, the input device includes a button, key, joystick and touch screen. Since the touch screen is easy and simple to operate, the touch screen is increasingly being used to operate the computing system.

The touch screen may constitute a touch surface of a touch input device including a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs operations in accordance with the analysis.

Recently, a touch input device is emerging, which is capable of detecting not only the touch position by touch on the touch screen but also the magnitude of touch pressure.

In particular, when the touch input device capable of detecting the magnitude of the touch pressure includes a separate pressure sensor added between a display module and a flexible printed circuit board (FPCB), the touch input device becomes thicker.

Further, when a pressure touch sensing function is adopted in a home button, the pressure sensor must be provided under the home button. However, when a separate pressure sensor is intended to be provided at the position of the home button, additional cost is required and the manufacturing process thereof becomes complicated.

### SUMMARY

One embodiment is a touch input device including a cover layer; a display module disposed under the cover layer; a substrate disposed apart from the display module at a predetermined distance; and a flexible printed circuit board (FPCB) on which a control circuit for controlling the operation of the display module is mounted. A pressure sensor for sensing touch pressure of an object is integrally formed in a partial area of the FPCB.

### BRIEF DESCRIPTION OF THE DRAWINGS

FIG. 1a to FIG. 1b are a schematic view of a capacitance type touch sensor according to an embodiment of the present invention and a configuration for the operation of the same;

FIG. 2 shows a control block for controlling a touch position, a touch pressure and a display operation in a touch input device according to the embodiment of the present invention;

FIGS. 3a and 3b are conceptual views for describing a configuration of a display module in the touch input device according to the embodiment of the present invention;

FIG. 4a to FIG. 4b are a cross sectional view of the touch input device configured to detect the touch pressure in accordance with the embodiment of the present invention;

FIG. 5a to FIG. 5d are a view showing a form of a pressure sensor which is included in the touch input device according to the embodiment of the present invention;

FIG. 6a to FIG. 6e is a view referred to for describing an FPCB in which the pressure sensor according to the embodiment of the present invention has been formed;

FIG. 7a to FIG. 7d are a cross sectional view of the touch input device including the FPCB including the pressure sensor of FIG. 6 formed therein;

FIG. 8 is a view referred to for showing an arrangement relationship between an insulation layer and the pressure sensor according to the embodiment of the present invention; and

FIG. 9 shows that a touch detection circuit for detecting the touch position has been integrated in a touch sensing IC mounted on a touch PCB.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, a touch input device 1000 according to an embodiment of the present invention will be described with reference to the accompanying drawings. While a capacitance type touch sensor 10 and a capacitance type pressure sensor 450 are exemplified below, the touch sensor 10 and the pressure sensor 450 which are capable of detecting a touch position and/or touch pressure in any manner may be applied.

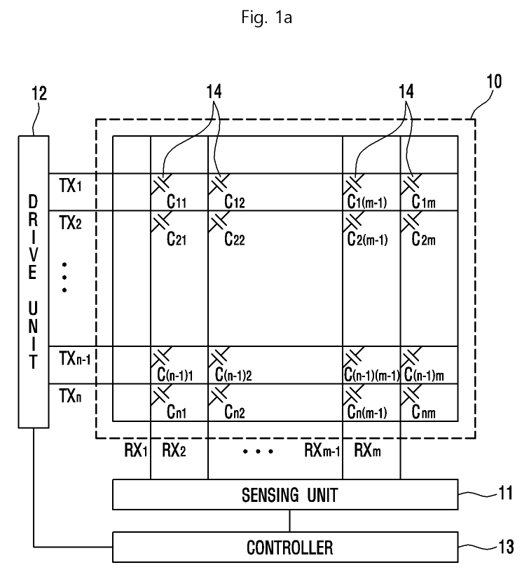

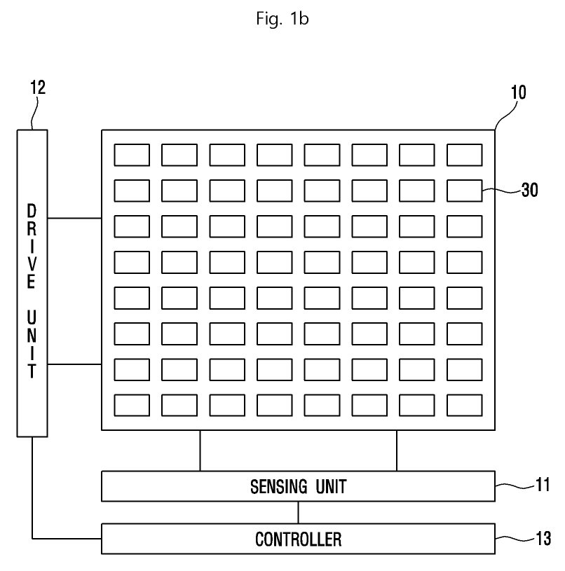

FIG. 1a is schematic views of a configuration of the capacitance type touch sensor 10 included in the touch input device 1000 according to the embodiment of the present invention and the operation of the capacitance type touch sensor. Referring to FIG. 1a, the touch sensor 10 may include a plurality of drive electrodes TX1 to TXn and a plurality of receiving electrodes RX1 to RXm, and may include a drive unit 12 which applies a drive signal to the plurality of the drive electrodes TX1 to TXn for the purpose of the operation of the touch sensor 10, and a sensing unit 11 which detects the touch and the touch position by receiving from the plurality of the receiving electrodes RX1 to RXm a sensing signal including information on a capacitance change amount changing according to the touch on a touch surface.

As shown in FIG. 1a, the touch sensor 10 may include the plurality of drive electrodes TX1 to TXn and the plurality of receiving electrodes RX1 to RXm. While FIG. 1a shows that the plurality of drive electrodes TX1 to TXn and the plurality of receiving electrodes RX1 to RXm of the touch sensor 10 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

The plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

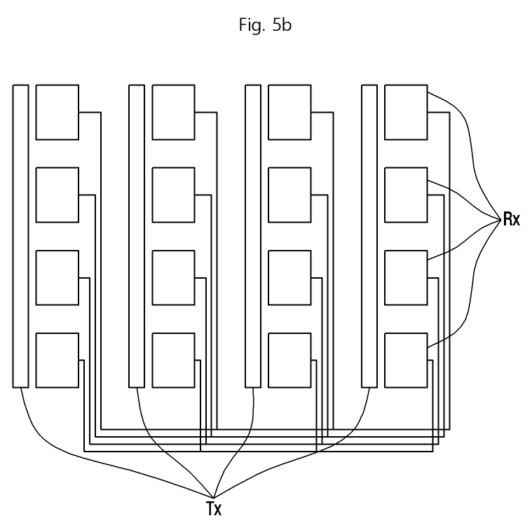

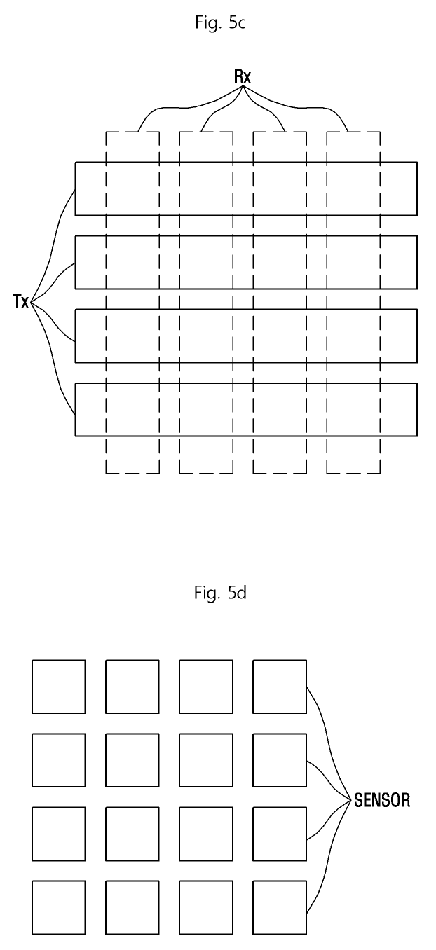

As shown in FIGS. 5a and 5b, in the touch sensor 10 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on a top surface of a display panel 200A to be described later.

Also, as shown in FIG. 5c, the plurality of drive electrodes TX1 to TXn and the plurality of receiving electrodes RX1 to RXm may be formed in different layers. For example, any one of the plurality of drive electrodes TX1 to TXn and the plurality of receiving electrodes RX1 to RXm may be formed on the top surface of the display panel 200A, and the other may be formed on a bottom surface of a cover to be described later or may be formed within the display panel 200A.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh.

The drive unit 12 according to the embodiment of the present invention may apply a drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 11 receives the sensing signal including information on a capacitance (Cm) 14 generated between the receiving electrodes RX1 to RXm and the drive electrodes TX1 to TXn to which the driving signal has been applied, thereby detecting whether or not the touch has occurred and where the touch has occurred. For example, the sensing signal may be a signal coupled by the capacitance (Cm) 14 generated between the receiving electrode RX and the drive electrode TX to which the driving signal has been applied. As such, the process of sensing the driving signal applied from the first drive electrode TX1 to the n-th drive electrode TXn through the receiving electrodes RX1 to RXm can be referred to as a process of scanning the touch sensor 10.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cm) 14, and then converts the integrated current signal into voltage. The sensing unit 11 may further include an analog to digital converter (ADC) (not shown) which converts the integrated data by the receiver into digital data. Later, the digital data may be input to a processor (not shown) and processed to obtain information on the touch on the touch sensor 10. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the driving signal can be applied to a predetermined drive electrode TX1 at a predetermined time. Also, the controller 13 generates and transmits the drive control signal to the sensing unit 11, so that the sensing unit 11 may receive the sensing signal from the predetermined receiving electrode RX at a predetermined time and perform a predetermined function.

In FIG. 1a, the drive unit 12 and the sensing unit 11 may constitute a touch detection device (not shown) capable of detecting whether the touch has occurred on the touch sensor 10 or not and where the touch has occurred. The touch detection device may further include the controller 13. In the touch input device 1000 including the touch sensor 10, the touch detection device may be integrated and implemented on a touch sensing integrated circuit (IC) corresponding to a below-described touch sensor controller 1100. The drive electrode TX and the receiving electrode RX included in the touch sensor 10 may be connected to the drive unit 12 and the sensing unit 11 included in the touch sensing IC through, for example, a conductive trace and/or a conductive pattern printed on a circuit board, or the like. The touch sensing IC may be placed on a circuit board on which the conductive pattern has been printed, for example, a touch circuit board (hereafter, referred to as a touch PCB). According to the embodiment, the touch sensing IC may be mounted on a mainboard for operation of the touch input device 1000.

As described above, a capacitance (Cm) with a predetermined value is generated at each crossing of the drive electrode TX and the receiving electrode RX. When an object like a finger approaches close to the touch sensor 10, the value of the capacitance may be changed. In FIG. 1a, the capacitance may represent a mutual capacitance (Cm). The sensing unit 11 senses such electrical characteristics, thereby being able to sense whether the touch has occurred on the touch sensor 10 or not and where the touch has occurred. For example, the sensing unit 11 is able to sense whether the touch has occurred on the surface of the touch sensor 10 comprised of a two-dimensional plane consisting of a first axis and a second axis.

More specifically, when the touch occurs on the touch sensor 10, the drive electrode TX to which the driving signal has been applied is detected, so that the position of the second axial direction of the touch can be detected. Likewise, when the touch occurs on the touch sensor 10, the capacitance change is detected from the reception signal received through the receiving electrode RX, so that the position of the first axial direction of the touch can be detected.

Up to now, although the operation mode of the touch sensor 10 sensing the touch position has been described on the basis of the mutual capacitance change amount between the drive electrode TX and the receiving electrode RX, the embodiment of the present invention is not limited to this. That is, as shown in FIG. 1b, it is also possible to detect the touch position on the basis of the change amount of a self-capacitance.

FIG. 1b is schematic views of a configuration of another capacitance type touch sensor 10 included in the touch input device 1000 according to another embodiment of the present invention and the operation of the capacitance type touch sensor. A plurality of touch electrodes 30 are provided on the touch sensor 10 shown in FIG. 1b. Although the plurality of touch electrodes 30 may be, as shown in FIG. 5d, disposed at a regular interval in the form of a grid, the present invention is not limited to this.

The drive control signal generated by the controller 13 is transmitted to the drive unit 12. On the basis of the drive control signal, the drive unit 12 applies the drive signal to the predetermined touch electrode 30 for a predetermined time period. Also, the drive control signal generated by the controller 13 is transmitted to the sensing unit 11. On the basis of the drive control signal, the sensing unit 11 receives the sensing signal from the predetermined touch electrode 30 for a predetermined time period. Here, the sensing signal may be a signal for the change amount of the self-capacitance formed on the touch electrode 30.

Here, whether the touch has occurred on the touch sensor 10 or not and/or the touch position are detected by the sensing signal detected by the sensing unit 11. For example, since the coordinate of the touch electrode 30 has been known in advance, whether the touch of the object on the surface of the touch sensor 10 has occurred or not and/or the touch position can be detected.

In the foregoing, for convenience of description, it has been described that the drive unit 12 and the sensing unit 11 operate individually as a separate block. However, the operation to apply the drive signal to the touch electrode 30 and to receive the sensing signal from the touch electrode 30 can be also performed by one drive and sensing unit.

The foregoing has described in detail the capacitance type touch sensor as the touch sensor 10. However, in the touch input device 1000 according to the embodiment of the present invention, the touch sensor 10 for detecting whether or not the touch has occurred and the touch position may be implemented by using not only the above-described method but also any touch sensing method such as a surface capacitance type method, a projected capacitance type method, a resistance film method, a surface acoustic wave (SAW) method, an infrared method, an optical imaging method, a dispersive signal technology, and an acoustic pulse recognition method, etc.

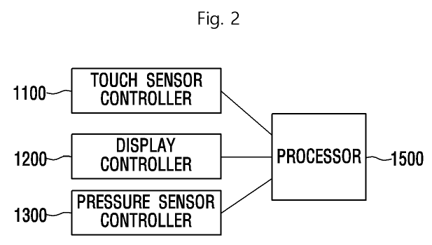

FIG. 2 shows a control block for controlling the touch position, a touch pressure and a display operation in the touch input device 1000 according to the embodiment of the present invention. In the touch input device 1000 configured to detect the touch pressure in addition to the display function and touch position detection, the control block may include the above-described touch sensor controller 1100 for detecting the touch position, a display controller 1200 for driving the display panel, and a pressure sensor controller 1300 for detecting the pressure. The touch sensor controller 1100 and the pressure sensor controller 1300 may be combined as one controller. The display controller 1200 may include a control circuit which receives an input from an application processor (AP) or a central processing unit (CPU) on a mainboard for the operation of the touch input device 1000 and displays the contents that the user wants on the display panel 200A. The control circuit may be mounted on a display circuit board (hereafter, referred to as a display PCB). The control circuit may include a display panel control IC, a graphic controller IC, and a circuit required to operate other display panel 200A.

The pressure sensor controller 1300 for detecting the pressure through the pressure sensor 450 may be configured similarly to the touch sensor controller 1100, and thus, may operate similarly to the touch sensor controller 1100. Specifically, as shown in FIGS. 1a and 1b, the pressure sensor controller 1300 may include the drive unit, the sensing unit, and the controller, and may detect a magnitude of the pressure by the sensing signal sensed by the sensing unit. Here, the pressure sensor controller 1300 may be mounted on the touch PCB on which the touch sensor controller 1100 has been mounted or may be mounted on a flexible printed circuit board (FPCB) on which the display controller 1200 has been mounted.

According to the embodiment, the touch sensor controller 1100, the display controller 1200, and the pressure sensor controller 1300 may be included as different components in the touch input device 1000. For example, the touch sensor controller 1100, the display controller 1200, and the pressure sensor controller 1300 may be composed of different chips respectively. Further, the pressure sensor controller 1300 and the touch sensor controller 1100 may be composed of the same chip. Here, a processor 1500 of the touch input device 1000 may function as a host processor for the touch sensor controller 1100, the display controller 1200, and the pressure sensor controller 1300.

The touch input device 1000 according to the embodiment of the present invention may include an electronic device including a display screen and/or a touch screen, such as a cell phone, a personal data assistant (PDA), a smartphone, a tablet personal computer (PC).

In order to manufacture such a slim and lightweight light-weighing touch input device 1000, the touch sensor controller 1100, the display controller 1200, and the pressure sensor controller 1300, which are, as described above, formed separately from each other, may be integrated into one or more configurations in accordance with the embodiment of the present invention. In addition to this, these controllers can be integrated into the processor 1500 respectively. Also, according to the embodiment of the present invention, the touch sensor 10 may be integrated into the display panel 200A.

In the touch input device 1000 according to the embodiment of the present invention, the touch sensor 10 for detecting the touch position may be positioned outside or inside the display panel 200A. The display panel 200A of the touch input device 1000 according to the embodiment of the present invention may be a display panel included in a liquid crystal display (LCD), a plasma display panel (PDP), an organic light emitting diode (OLED), etc. Accordingly, a user may perform the input operation by touching the touch surface while visually identifying an image displayed on the display panel.

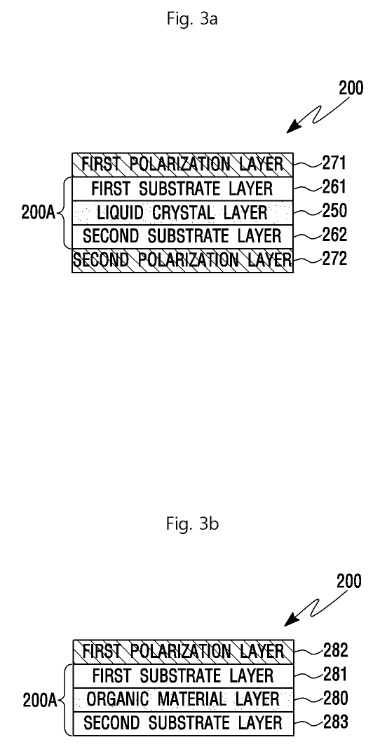

FIGS. 3a and 3b are conceptual views for describing a configuration of a display module 200 in the touch input device 1000 according to the embodiment of the present invention. First, the configuration of the display module 200 including the display panel 200A using an LCD panel will be described with reference to FIG. 3a.

As shown in FIG. 3a, the display module 200 may include the display panel 200A that is an LCD panel, a first polarization layer 271 disposed on the display panel 200A, and a second polarization layer 272 disposed under the display panel 200A. The display panel 200A that is an LCD panel may include a liquid crystal layer 250 including a liquid crystal cell, a first substrate layer 261 disposed on the liquid crystal layer 250, and a second substrate layer 262 disposed under the liquid crystal layer 250. Here, the first substrate layer 261 may be made of color filter glass, and the second substrate layer 262 may be made of TFT glass. Also, according to the embodiment, at least one of the first substrate layer 261 and the second substrate layer 262 may be made of a bendable material such as plastic. In FIG. 3a, the second substrate layer 262 may be comprised of various layers including a data line, a gate line, TFT, a common electrode, and a pixel electrode, etc. These electrical components may operate in such a manner as to generate a controlled electric field and orient liquid crystals located in the liquid crystal layer 250.

Next, the configuration of the display module 200 including the display panel 200A using an OLED panel will be described with reference to FIG. 3b.

As shown in FIG. 3b, the display module 200 may include the display panel 200A that is an OLED panel, and a first polarization layer 282 disposed on the display panel 200A. The display panel 200A that is an OLED panel may include an organic material layer 280 including an organic light-emitting diode (OLED), a first substrate layer 281 disposed on the organic material layer 280, and a second substrate layer 283 disposed under the organic material layer 280. Here, the first substrate layer 281 may be made of encapsulation glass, and the second substrate layer 283 may be made of TFT glass. Also, according to the embodiment, at least one of the first substrate layer 281 and the second substrate layer 283 may be made of a bendable material such as plastic. The OLED panel may include an electrode used to drive the display panel 200A, such as a gate line, a data line, a first power line (ELVDD), a second power line (ELVSS), etc. The organic light-emitting diode (OLED) panel is a self-light emitting display panel which uses a principle where, when current flows through a fluorescent or phosphorescent organic thin film and then electrons and electron holes are combined in the organic material layer, so that light is generated. The organic material constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains a good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

Also, the organic material layer 280 may include a hole injection layer (HIL), a hole transport layer (HTL), an electron injection layer (EIL), an electron transport layer (ETL), and an light-emitting layer (EML).

Briefly describing each of the layers, HIL injects electron holes and is made of a material such as CuPc, etc. HTL functions to move the injected electron holes and mainly is made of a material having a good hole mobility. Arylamine, TPD, and the like may be used as the HTL. The EIL and ETL inject and transport electrons. The injected electrons and electron holes are combined in the EML and emit light. The EML represents the color of the emitted light and is composed of a host determining the lifespan of the organic matter and an impurity (dopant) determining the color sense and efficiency. This just describes the basic structure of the organic material layer 280 include in the OLED panel. The present invention is not limited to the layer structure or material, etc., of the organic material layer 280.

The organic material layer 280 is inserted between an anode (not shown) and a cathode (not shown). When the TFT becomes an on-state, a driving current is applied to the anode and the electron holes are injected, and the electrons are injected to the cathode. Then, the electron holes and electrons move to the organic material layer 280 and emit the light.

It will be apparent to a skilled person in the art that the LCD panel or the OLED panel may further include other structures so as to perform the display function and may be deformed.

The display module 200 of the touch input device 1000 according to the embodiment of the present invention may include the display panel 200A and a configuration for driving the display panel 200A. Specifically, when the display panel 200A is an LCD panel, the display module 200 may include a backlight unit (not shown) disposed under the second polarization layer 272 and may further include a display panel control IC for operation of the LCD panel, a graphic control IC, and other circuits.

In the touch input device 1000 according to the embodiment of the present invention, the touch sensor 10 for detecting the touch position may be positioned outside or inside the display module 200.

When the touch sensor 10 in the touch input device 1000 positioned outside the display module 200, the touch sensor panel may be disposed on the display module 200, and the touch sensor 10 may be included in the touch sensor panel. The touch surface of the touch input device 1000 may be the surface of the touch sensor panel.

When the touch sensor 10 in the touch input device 1000 positioned inside the display module 200, the touch sensor 10 may be configured to be positioned outside the display panel 200A. Specifically, the touch sensor 10 may be formed on the top surfaces of the first substrate layers 261 and 281. Here, the touch surface of the touch input device 1000 may be an outer surface of the display module 200 and may be the top surface or bottom surface in FIGS. 3 and 3b.

When the touch sensor 10 in the touch input device 1000 positioned inside the display module 200, at least a portion of the touch sensor 10 may be configured to be positioned inside the display panel 200A, and at least a portion of the remaining touch sensor 10 may be configured to be positioned outside the display panel 200A. For example, any one of the drive electrode TX and the receiving electrode RX, which constitute the touch sensor 10, may be configured to be positioned outside the display panel 200A, and the other may be configured to be positioned inside the display panel 200A. Specifically, any one of the drive electrode TX and the receiving electrode RX, which constitute the touch sensor 10, may be formed on the top surface of the top surfaces of the first substrate layers 261 and 281, and the other may be formed on the bottom surfaces of the first substrate layers 261 and 281 or may be formed on the top surfaces of the second substrate layers 262 and 283.

When the touch sensor 10 in the touch input device 1000 positioned inside the display module 200, the touch sensor 10 may be configured to be positioned inside the display panel 200A. Specifically, the touch sensor 10 may be formed on the bottom surfaces of the first substrate layers 261 and 281 or may be formed on the top surfaces of the second substrate layers 262 and 283.

When the touch sensor 10 is positioned inside the display panel 200A, an electrode for operation of the touch sensor may be additionally disposed. However, various configurations and/or electrodes positioned inside the display panel 200A may be used as the touch sensor 10 for sensing the touch. Specifically, when the display panel 200A is the LCD panel, at least any one of the electrodes included in the touch sensor 10 may include at least any one of a data line, a gate line, TFT, a common electrode (Vcom), and a pixel electrode. When the display panel 200A is the OLED panel, at least any one of the electrodes included in the touch sensor 10 may include at least any one of a data line, a gate line, a first power line (ELVDD), and a second power line (ELVSS).

Here, the touch sensor 10 may function as the drive electrode and the receiving electrode described in FIG. 1a and may detect the touch position in accordance with the mutual capacitance between the drive electrode and the receiving electrode. Also, the touch sensor 10 may function as the single electrode 30 described in FIG. 1b and may detect the touch position in accordance with the self-capacitance of each of the single electrodes 30. Here, if the electrode included in the touch sensor 10 is used to drive the display panel 200A, the touch sensor 10 may drive the display panel 200A in a first time interval and may detect the touch position in a second time interval different from the first time interval.

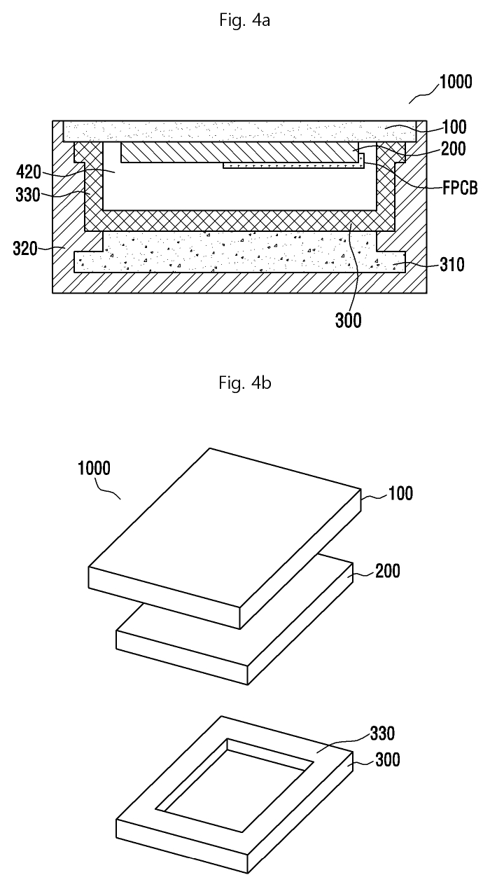

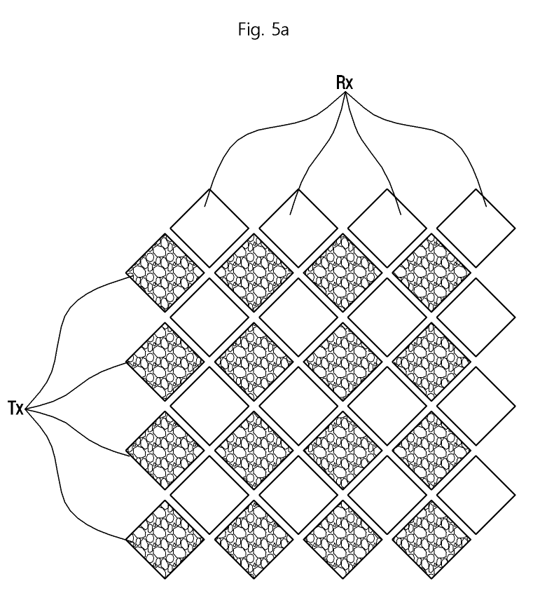

FIG. 4a is a cross sectional view of the touch input device 1000 according to the embodiment of the present invention.

In the touch input device 1000 according to the embodiment of the present invention, by means of an adhesive like an optically clear adhesive (OCA), lamination may occur between a cover layer 100 on which the touch sensor for detecting the touch position has been formed and the display module 200 including the display panel 200A. As a result, the display color clarity, visibility and optical transmittance of the display module 200, which can be recognized through the touch surface of the touch sensor, can be improved.

In the touch input device 1000 according to the embodiment of the present invention, a substrate 300, together with an outermost housing 320 of the touch input device 1000, may function to surround a mounting space 310, etc., where the circuit board and/or battery for operation of the touch input device 1000 are placed. Here, the circuit board for operation of the touch input device 1000 may be a mainboard. A central processing unit (CPU), an application processor (AP) or the like may be mounted on the circuit board. Due to the substrate 300, the display module 200 is separated from the circuit board and/or battery for operation of the touch input device 1000. Due to the substrate 300, electrical noise generated from the display module 200 and noise generated from the circuit board can be blocked.

The touch sensor 10 or the cover layer 100 of the touch input device 1000 may be formed wider than the display module 200, the substrate 300, and the mounting space 310. As a result, the housing 320 may be formed such that the housing 320, together with the touch sensor 10, surrounds the display module 200, the substrate 300, and the circuit board.

As shown in FIG. 4a, the touch input device 1000 according to the embodiment of the present invention may include a spacer layer 420 which separates the display module 200 from the substrate 300. The FPCB on which a circuit for driving the display has been implemented may be disposed under the display module 200. Here, according to the embodiment, the spacer layer 420 may be made of an impact absorbing material. According to the embodiment, the spacer layer 420 may be filled with a dielectric material. According to the embodiment, the spacer layer 420 may be made of a material having a restoring force by which the material contracts by applying the pressure and returns to its original shape by releasing the pressure. According to the embodiment, the spacer layer 420 may be made of elastic foam.

Here, as shown in FIG. 4b, a frame 330 having a predetermined height may be formed along the border of the upper portion of the substrate 300 in order to maintain the spacer layer 420 in which the pressure sensor 450 and 460 are disposed. Here, the frame 330 may be bonded to the cover layer 100 by means of an adhesive tape (not shown). While FIG. 4b shows the frame 330 is formed on the entire border (e.g., four sides of the quadrangle) of the substrate 300, the frame 330 may be formed only on at least some (e.g., three sides of the quadrangle) of the border of the substrate 300. According to the embodiment, the frame 330 may be formed on the top surface of the substrate 300 may be integrally formed with the substrate 300 on the top surface of the substrate 300. In the embodiment of the present invention, the frame 330 may be made of an inelastic material. In the embodiment of the present invention, when touch pressure is applied to the display module 200 through the cover layer 100, the display module 200, together with the cover layer 100, may be bent. Therefore, the magnitude of the touch pressure can be detected even though the frame 330 is not deformed by the pressure.

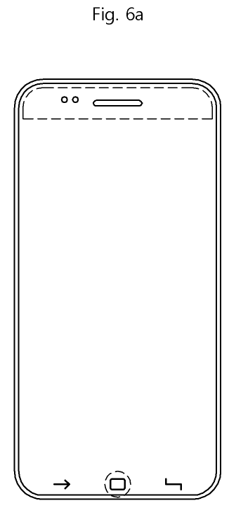

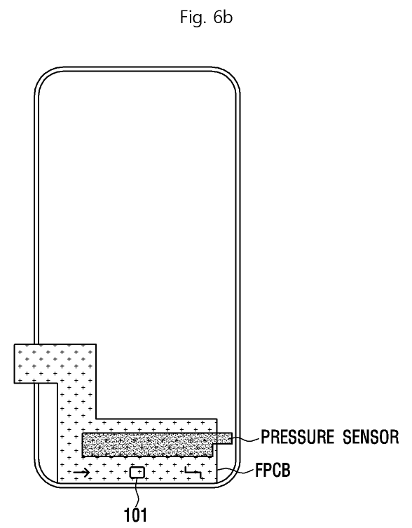

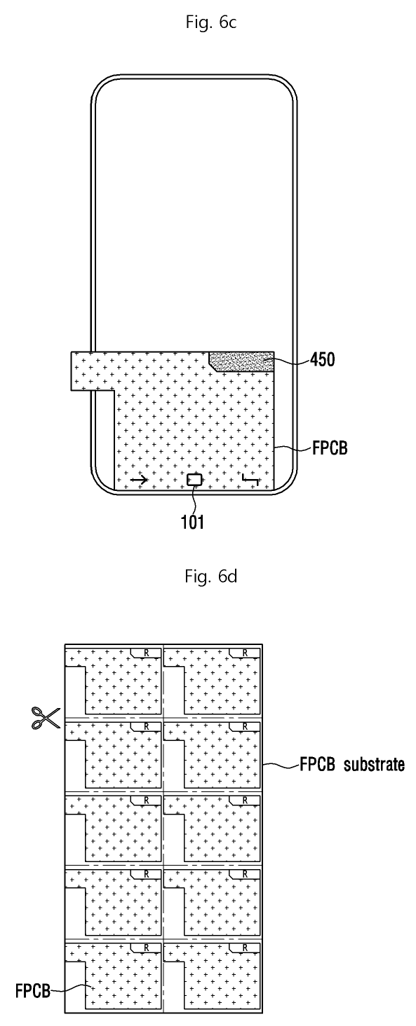

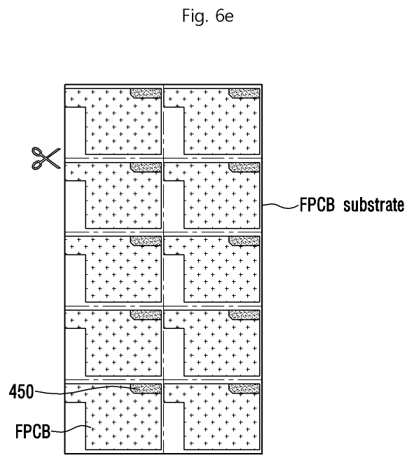

In a conventional touch input device 1000, when touch pressure is, as shown in FIG. 6a, applied to a home key (dotted-line part) on the cover layer 100, the magnitude of the touch pressure is, as shown in FIG. 6b, detected by the pressure sensor located under the home key 101. As such, when the touch input device 1000 includes a pressure sensor added separately between the display module 200 and the flexible printed circuit board (FPCB), the touch input device 1000 becomes thicker. Here, there is a requirement for making the touch input device 1000 relatively thinner by using the FPCB itself as the pressure sensor 450 without additionally including a separate pressure sensor.

Also, when a predetermined FPCB is separated from one piece of FPCB in order to manufacture the FPCB which is disposed in the touch input device 1000, a part of the manufacturing cost of the touch input device is wasted because the remaining portion other than the predetermined FPCB separated from one piece of FPCB is discarded. Therefore, there is a need to reduce the cost by using the remaining portion as the pressure sensor 450 without adding a separate pressure sensor.

Here, in the embodiment of the present invention, an example of using a portion of the FPCB as the pressure sensor 450 will be described.

As shown in FIG. 6c, the pressure sensor 450 for sensing the touch pressure of the object may be formed in a partial area of the FPCB. In the embodiment of the present invention, the object may include a finger or a stylus. The touch pressure means that pressure with a magnitude greater than a predetermined threshold value is applied.

A ratio of the area of the pressure sensor 450 to area of the FPCB may be preset during the design for manufacture of the touch input device 1000. FIG. 6c shows that the pressure sensor 450 is formed on a portion of the right corner of the FPCB, the scope of the present invention is not limited thereto. That is, the pressure sensor 450 may be formed on a portion of the left corner, a portion of the upper corner, or a portion of the lower corner of the FPCB, or may be formed on a plurality of portions of the corner or in any other area of the FPCB.

The partial area of the FPCB where the pressure sensor 450 is formed may be spaced apart at a predetermined distance from the home key 101 on the cover layer 100.

Since the portion of the FPCB is, as shown in FIG. 6c, used as the pressure sensor 450 without adding a separate pressure sensor under the home key 101, the pressure sensor 450 may be formed to be spaced from the home key 101 at a predetermined distance. The spaced distance of the pressure sensor 450 from the home key 101 may be preset during the design for manufacture of the touch input device 1000.

The touch input device 1000 includes the touch sensor for sensing the touch of the object. In a case where a pressure with a magnitude greater than a predetermined reference value is, as shown in FIG. 6c, sensed by the pressure sensor 450, not only the pressure applied to the position of the home key 101 but also the pressure applied to the remaining region other than the home key 101 (for example, the portion of the cover layer 100 which corresponds to the pressure sensor 450) can be sensed. Here, if even the touch pressure applied to the remaining region other than the home key is recognized as the touch pressure applied to the home key 101, there may be confusion in controlling the function of the touch input device 1000. Accordingly, when the touch pressure is applied, the processor 1500 or the controller 13 according to the embodiment of the present invention determines that the touch pressure is applied to the home key 101 only when the touch position of the object sensed by the touch sensor is the position of the home key 101.

When the touch pressure is applied to the home key 101, a function corresponding to the touch pressure may be performed. For example, when the magnitude of pressure applied to the home key 101 is equal to or greater than a predetermined value, an initial screen can be displayed on the display module 200.

As shown in FIGS. 6d and 6e, the FPCB in which the pressure sensor 450 according to the embodiment of the present invention is formed may be provided by dividing one piece of FPCB into a plurality of FPCBs. As described above, in the past, the remaining portions R other than respective FPCBs provided by dividing, as shown in FIG. 6d, one piece of FPCB into a plurality of FPCBs were not used. However, in the present invention, the remaining portions other than the respective FPCBs provided by dividing, as shown in FIG. 6e, one piece of FPCB into a plurality of FPCBs can be used as the pressure sensor 450. Here, the number of FPCBs which are, as shown in FIG. 6d, provided by dividing one piece of FPCB and are composed of only the region other than the pressure sensor 450 is made to be equal to the number of FPCBs which are provided by dividing one piece of FPCB and are composed of the region including the pressure sensor 450. In other words, when the number of FPCBs which are, as shown in FIG. 6d, provided by dividing one piece of FPCB and are composed of only the region other than the pressure sensor 450 is 10, within a range in which the number of FPCBs which are provided by dividing one piece of FPCB and are composed of the region including the pressure sensor 450 is also 10, the remaining portion may be available as the pressure sensor 450. Therefore, it is possible not only to maintain the number of manufacturable FPCBs but also to utilize the remaining portion of one piece of FPCB.

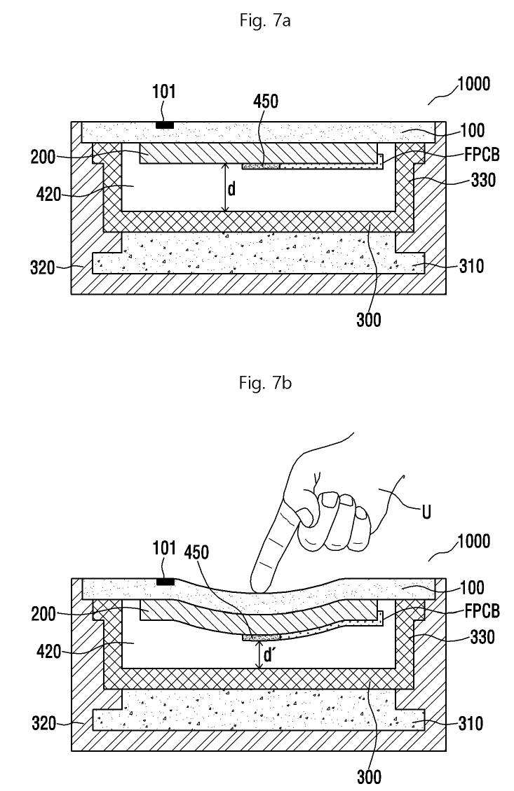

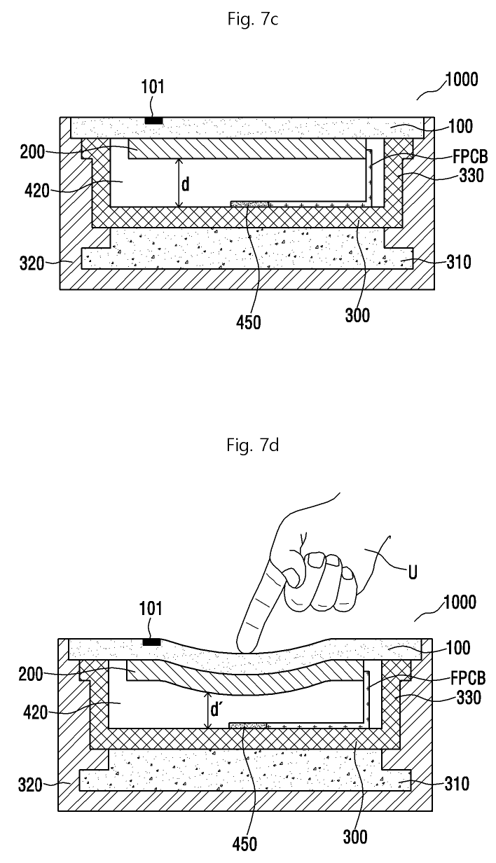

FIG. 7 is a cross sectional view of the touch input device 1000 including the FPCB including the pressure sensor 450 of FIG. 6 formed therein.

As shown in FIG. 7a, the pressure sensor 450 according to the embodiment of the present invention may be formed within the spacer layer 420 and on the FPCB disposed on the bottom surface of the display module 200.

The pressure sensor 450 may include a first sensor 451 and a second sensor 452. Here, any one of the first sensor 451 and the second sensor 452 may be a drive electrode, and the other may be a receiving electrode. A drive signal is applied to the drive electrode, and a sensing signal may be obtained through the receiving electrode. When a voltage is applied, a mutual capacitance may be generated between the first sensor 451 and the second sensor 452.

FIG. 7b is a cross sectional view when a pressure is applied to the touch input device 1000 shown in FIG. 7a. The substrate 300 may have a ground potential for shielding the noise. When a pressure is applied to the surface of the cover layer 100 by the object, the cover layer 100 and the display module 200 may be bent. When the FPCB is attached to the bottom surface of the display module 200, the FPCB may be bent. As a result, a distance “d” between the ground potential surface and the pressure sensor 450 may be decreased to “d′”. In this case, due to the decrease of the distance “d”, the mutual capacitance between the first sensor 451 and the second sensor 452 may be reduced. Therefore, the magnitude of the touch pressure can be calculated by obtaining the reduction amount of the mutual capacitance from the sensing signal obtained through the receiving electrode.

Although it has been described in FIG. 7b that the top surface of the substrate 300 has the ground potential, that is to say, is the reference potential layer, the reference potential layer may be disposed inside the display module 200. Here, when a pressure is applied to the surface of the cover layer 100 by the object, the cover layer 100 and the display module 200 may be bent or pressed. As a result, a distance between the pressure sensor 450 and the reference potential layer disposed inside the display module 200 is changed. Therefore, the magnitude of the touch pressure can be calculated by obtaining the capacitance change amount from the sensing signal obtained through the receiving sensor.

In the touch input device 1000 according to the embodiment of the present invention, the display module 200 may be bent by the touch applying the pressure. The display module 200 may be bent in such a manner as to show the largest deformation at the touch position. When the display module 200 is bent according to the embodiment, a position showing the biggest transformation may not match the touch position. However, the display module 200 may be shown to be bent at least at the touch position. For example, when the touch position approaches close to the border, edge, etc., of the display module 200, the most bent position of the display module 200 may not match the touch position, however, the display module 200 may be shown to be bent at least at the touch position.

In the state where the first sensor 451 and the second sensor 452 are formed in the same layer, each of the first sensor 451 and the second sensor 452 which constitute the pressure sensor 450 shown in FIG. 7b, may be, as shown in FIG. 5a, composed of a plurality of lozenge-shaped sensors. Here, the plurality of the first sensors 451 are connected to each other in the first axial direction, and the plurality of the second sensors 452 are connected to each other in the second axial direction orthogonal to the first axial direction. The lozenge-shaped sensors of at least one of the first sensor 451 and the second sensor 452 are connected to each other through a bridge, so that the first sensor 451 and the second sensor 452 may be insulated from each other. Also, here, each of the first sensor 451 and the second sensor 452 which constitute the pressure sensor 450 shown in FIG. 7b may be composed of a sensor having a form shown in FIG. 5b.

In the foregoing, it is shown that the touch pressure is detected from the change of the mutual capacitance between the first sensor 451 and the second sensor 452. However, the pressure sensor 450 may be configured to include only any one of the first sensor 451 and the second sensor 452. In this case, it is possible to detect the magnitude of the touch pressure by detecting the change of the capacitance between the one pressure sensor and a ground layer (the reference potential layer disposed inside the display module 200 or the substrate 300), that is to say, the change of the self-capacitance. Here, as shown in FIG. 5d, the drive signal is applied to the one pressure sensor, and the change of the self-capacitance between the pressure sensor and the ground layer can be detected by the pressure sensor.

For instance, in FIG. 7b, the pressure sensor 450 may be configured to include only the first sensor 451. Here, the magnitude of the touch pressure can be detected by the change of the capacitance between the first sensor 451 and the substrate 300, which is caused by a distance change between the substrate 300 and the first sensor 451. Since the distance “d” is reduced with the increase of the touch pressure, the capacitance between the substrate 300 and the first sensor 451 may be increased with the increase of the touch pressure. Here, the pressure sensor should not necessary have a comb teeth shape or a trident shape, which is required to improve the detection accuracy of the mutual capacitance change amount. The pressure sensor may have a plate shape (e.g., quadrangular plate). Or, as shown in FIG. 5d, the plurality of the first sensors 451 may be disposed at a regular interval in the form of a grid.

While FIGS. 7a and 7b show that the FPCB is disposed on the bottom surface of the display module 200, the FPCB may be, as shown in FIGS. 7c and 7d, disposed on the top surface of the substrate 300. In this case, the bottom surface or inside of the display module 200 may have a ground potential for shielding the noise.

When the object applies a pressure to the surface of the cover layer 100, the cover layer 100 and the display module 200 may be bent. As a result, a distance “d” between the ground potential surface and the first sensor 450 may be reduced to “d′”. In this case, the mutual capacitance between the first sensor 451 and the second sensor 452 may be reduced with the reduction of the distance “d”. Therefore, the magnitude of the touch pressure can be calculated by obtaining the reduced amount of the mutual capacitance from the sensing signal obtained through the receiving electrode.

Besides, the characteristics of the self-capacitance change described in FIGS. 7a and 7b can be applied in the same manner to FIGS. 7c and 7d.

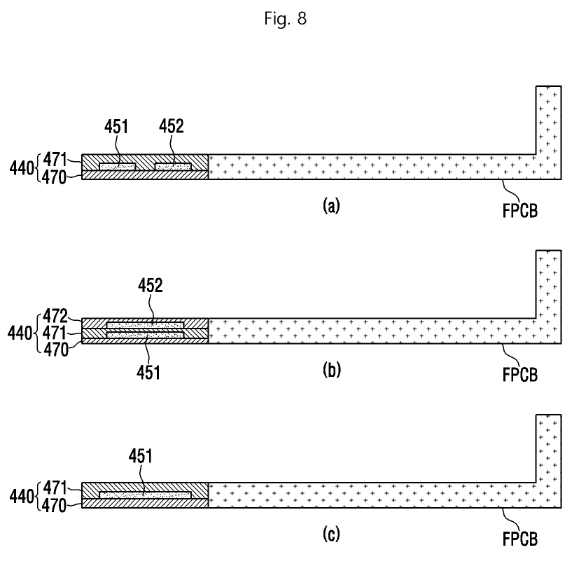

FIG. 8 is a view referred to for showing an arrangement relationship between insulation layers 470 and 471 and the pressure sensors 451 and 452 according to the embodiment of the present invention. In (a) of FIG. 8, a short-circuit can be prevented from occurring between the pressure sensors 451 and 452 and either the substrate 300 or the display module 200 because the pressure sensors 451 and 452 are disposed between the first insulation layer 470 and the second insulation layer 471. Depending on the type and/or implementation method of the touch input device 1000, the substrate 300 or the display module 200 may not have the ground potential or may have a weak ground potential. In this case, the touch input device 1000 according to the embodiment of the present invention may further include a ground electrode (not shown) between the insulation layer 470 and either the substrate 300 or the display module 200. According to the embodiment of the present invention, the touch input device 1000 invention may further include another insulation layer (not shown) between the ground electrode and either the substrate 300 or the display module 200. Here, the ground electrode (not shown) is able to prevent the size of the capacitance generated between the first sensor 451 and the second sensor 452, which are pressure sensors, from increasing excessively.

It is possible to consider that the first sensor 451 and the second sensor 452 may be formed in different layers in accordance with the embodiment of the present invention. In (b) of FIG. 8, the cross sectional view shows that the first sensor 451 and the second sensor 452 are formed in different layers. As shown in (b) of FIG. 8, the first sensor 451 may be formed on the first insulation layer 470, and the second sensor 452 may be formed on the second insulation layer 471 located on the first sensor 451. According to the embodiment of the present invention, the second sensor 452 may be covered with a third insulation layer 472. Here, the first sensor 451 and the second sensor 452 may be implemented so as to overlap each other because they are disposed in different layers. For example, the first sensor 451 and the second sensor 452 may be, as shown in FIG. 5c, formed similarly to the pattern of the drive electrode TX and receiving electrode RX which are arranged in the form of M×N array. Here, M and N may be natural numbers greater than 1. Also, as shown in FIG. 5a, the lozenge-shaped first sensor 451 and the lozenge-shaped second sensor 452 may be located in different layers respectively.

In (c) of FIG. 8, the cross sectional view shows that the pressure sensor 450 is implemented to include only the first sensor 451. As shown in (c) of FIG. 8, a short-circuit can be prevented from occurring between the pressure sensors 451 and 452 and either the substrate 300 or the display module 200 because the first sensor 451 is disposed between the first insulation layer 470 and the second insulation layer 471.

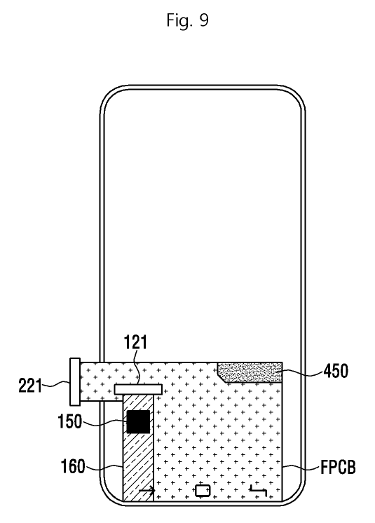

Meanwhile, FIG. 9 shows a method in which the pressure sensor 450 is formed in a portion of the FPCB and is connected to a touch sensing IC 150. In the FPCB, a conductive pattern may be printed which electrically connects not only a circuit necessary for driving the display module 200 but also a required configuration such as the touch sensing IC 150.

FIG. 9 shows that a touch detection circuit for detecting the touch position has been integrated in the touch sensing IC mounted on a touch PCB 160. The pressure sensor 405 that is a part of the FPCB may be connected to the touch sensing IC 150 through a first connector 121. That is, the first connector 121 is disposed between the touch PCB 160 and the FPCB, and the pressure sensor 450 is electrically connected to the touch detection circuit through the first connector 121. As shown in FIG. 9, in a mobile communication device such as a smartphone, the touch sensing IC 150 is connected to the FPCB for the display module 200 through the first connector 121. The FPCB may be electrically connected to the mainboard through a second connector 221. Therefore, the touch sensing IC 150 can transmit and receive signals to and from the CPU or AP for the operation of the touch input device 1000 through the first connector 121 and the second connector 221.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A touch input device comprising:
a cover layer;
a display module disposed under the cover layer;
a substrate disposed apart from the display module at a predetermined distance; and
a flexible printed circuit board (FPCB) on which a control circuit for controlling the operation of the display module is mounted,
wherein a pressure sensor for sensing touch pressure of an object is formed in a partial area of the FPCB.

2. The touch input device of claim 1, wherein the partial area of the FPCB is spaced apart at a predetermined distance from a home key on the cover layer.

3. The touch input device of claim 2, further comprising:
a touch sensor for sensing touch of the object; and
a processor which, in a case where pressure with a magnitude greater than a predetermined reference value is sensed by the pressure sensor, determines that the touch pressure is applied to the home key only when a touch position of the object sensed by the touch sensor is a position of the home key.

4. The touch input device of claim 1,
wherein the FPCB is any one of a plurality of FPCBs obtained by dividing one piece of FPCB,
and wherein the number of FPCBs which are provided by dividing one piece of FPCB and are composed of only a region other than the pressure sensor is equal to the number of FPCBs which are provided by dividing one piece of FPCB and are composed of a region including the pressure sensor.

5. The touch input device of claim 3, wherein, when the touch pressure is applied to the home key, a function corresponding to the touch pressure is performed.

6. The touch input device of claim 1,
wherein the FPCB is disposed on a bottom surface of the display module,
and wherein the touch pressure is detected by a capacitance change amount according to a distance change between the pressure sensor and the substrate.

7. The touch input device of claim 1,
wherein the FPCB is disposed on a top surface of the substrate,
and wherein the touch pressure is detected by a capacitance change amount according to a distance change between the pressure sensor and the display module.

8. The touch input device of claim 6,
wherein the pressure sensor comprises a drive electrode and a receiving electrode,
and wherein the touch pressure is detected by a mutual capacitance change amount between the drive electrode and the receiving electrode.

9. The touch input device of claim 6, wherein the touch pressure is detected by a self-capacitance change amount of the pressure sensor.
